(19) United States
(12) Patent Application Publication
(10) Pub. No.: US 2003/0103720 A1
(43) Pub. Date: Jun. 5, 2003

(54) Mechanical optical switch

(76) Inventor: Yao-Hao Chang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/098,325

(22) Filed: Mar. 15, 2002

(30) Foreign Application Priority Data
Dec. 5, 2001 (TW) 90221148

(51) Int. Cl. G02B 6/35; G02B 6/26

(52) U.S. Cl. 385/22; 385/18; 385/25

(57) ABSTRACT

An optical switch (1) includes an optical input device (20), a plurality of optical output devices (30), a driving device (40), a movable reflection device (50) and a fixed reflection member (60) both mounted in a fixing base (70), a casing (11), and a cover (12) attached to the casing. The input device and the output devices respectively convey optical signals into and out of the optical switch. The fixed reflection member reflects incoming optical signals to the movable reflection member. The movable reflection member reflects the reflected optical signals into a desired output device. A transmitting rod (43) of the driving device drives the movable reflection member along a guide rod (53). The movable reflection member can thus be positioned to correspond to an optical path of the desired output device. Therefore, switching between a variety of output devices is easily performed.

### BACKGROUND OF THE INVENTION

1. Field of the Invention

The present invention relates to an optical switch, and more particularly to a mechanical optical switch which has low insertion loss and is readily assembled.

2. Description of the Related Art

Optical switches are widely used in optical networks. Optical switches are usually classified as either mechanical or non-mechanical. Mechanical optical switches accomplish switching between two or more outputs by moving optical fibers or optical elements using mechanical or electromagnetic means. Since an optical fiber is generally very thin, moving an optical fiber to switch between outputs is prone to error. This may cause undesired loss of optical signals. On the other hand, moving an optical element rather than an optical fiber to perform switching is more advantageous. Such a mechanism results in an insertion loss of less than 2 dB while still yielding high isolation, sometimes as high as 45 dB. In addition, such mechanism is independent of polarization and wavelength of incoming optical signals. Movable optical elements in such mechanisms comprise reflectors, lenses, and prisms. Reflectors are the most popular of these movable optical elements.

U.S. Pat. No. 5,867,617 discloses a mechanical optical switch comprising an input assembly, and first and second output assemblies. Switching is effected by a prism located between collimating lenses. The prism redirects optical signals to an alternative lens. The prism preferably has a cross-section of a parallelogram. Each optical signal is reflected twice within the prism to minimize cross-sectional distortion and avoid spectral effects. However, the optical switch comprises an excessive number of parts. This results in excessive angular tolerance and distance tolerance, which in turn results in high insertion loss.

In view of the above, it is desired to provide a mechanical optical switch which has relatively few parts needed to accomplish optical path switching, and which has low insertion loss.

### SUMMARY OF THE INVENTION

Therefore, an object of the present invention is to provide an optical switch which has low insertion loss.

Another object of the present invention is to provide an optical switch which can be easily and quickly assembled.

A further object of the present invention is to provide an optical switch which is inexpensive.

To achieve the above objects, an optical switch in accordance with the present invention includes an optical input device, a plurality of optical output devices, a driving device, a movable reflection device and a fixed reflection member both mounted in a fixing base, a casing, and a cover attached to the casing. The input device and output devices respectively convey optical signals into and out of the optical switch. The fixed reflection member reflects incoming optical signals to the movable reflection member. The movable reflection member reflects the reflected optical signals into a desired output device. A transmitting rod of the driving device drives the movable reflection member along a guide rod. The movable reflection member can thus be positioned to correspond to an optical path of the desired output device. Therefore, switching between a variety of output devices is easily performed.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a perspective view of an optical switch in accordance with the present invention;

FIG. 2 is an exploded view of FIG. 1;

FIG. 3 is a partly assembled view of FIG. 2; and

FIGS. 4 and 5 are schematic top plan views of the optical switch of FIG. 1, illustrating use of the optical switch to switch optical paths.

### DETAILED DESCRIPTION OF THE INVENTION

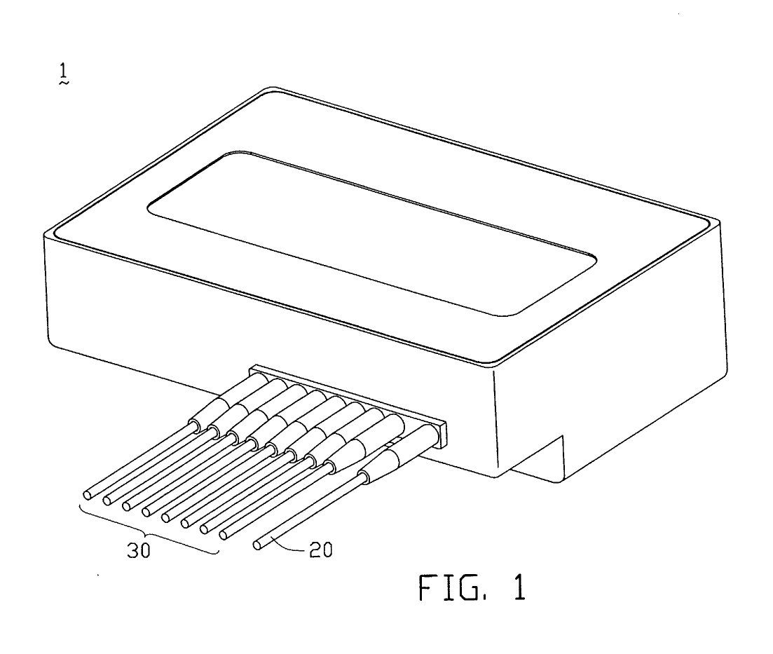

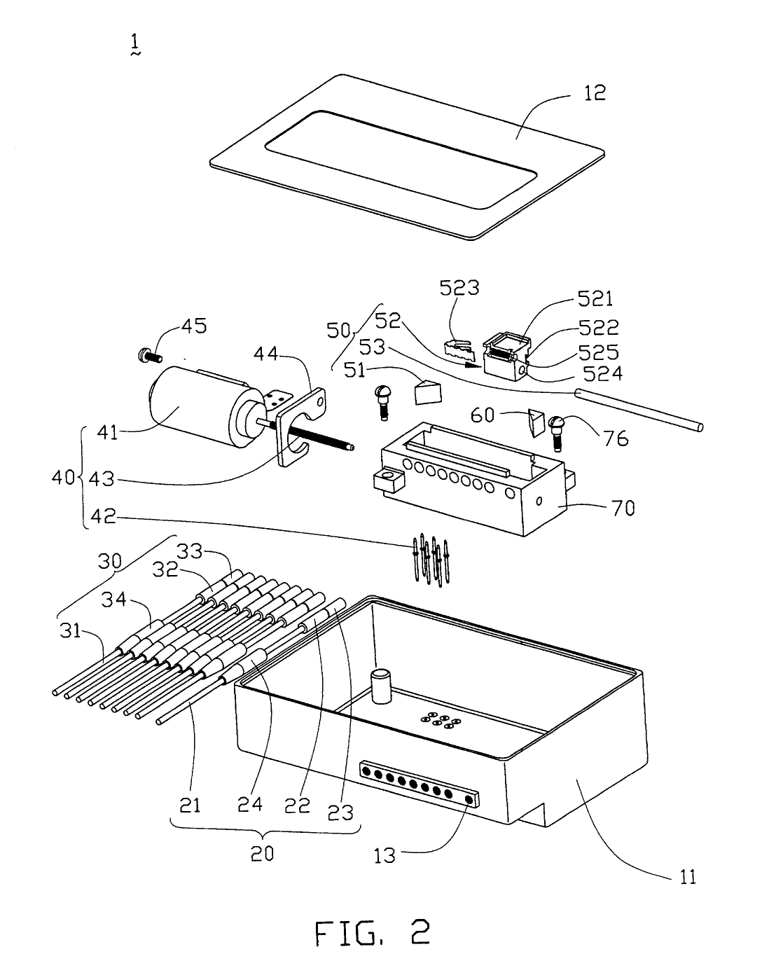

Referring to FIGS. 1 and 2, an optical switch 1 includes a casing 11, and a cover 12 attached on the casing 11. The casing 11 and cover 12 cooperatively define a substantially sealed interior space therebetween for accommodating movable and fixed parts of the optical switch 1. The movable and fixed parts include an optical input device 20, a plurality of optical output devices 30, a driving device 40, and a movable reflection device 50 and a fixed reflection member 60 both mounted in a fixing base 70. A plurality of horizontally aligned first fixing holes 13 is defined in a front wall of the casing 11, to accommodate the optical input and output devices 20, 30.

The input device 20 includes an input optical fiber 21 attached in a ferrule 22, and a collimating lens 23 attached to an end of the ferrule 22. A securing member 24 covers part of the input fiber 21, for protecting the input fiber 21. An input optical path is defined through the input fiber 21 and the collimating lens 23. Each output device 30 includes an output optical fiber 31, a ferrule 32, a collimating lens 33, and a securing member 34. An output optical path is defined through the output fiber 31 and its corresponding collimating lens 33. Thus the optical switch 1 has the input optical path and a plurality of output optical paths.

The driving device 40 includes a stepping motor 41 which electrically connects with a plurality of terminals 42, and a threaded transmitting rod 43 attached to the stepping motor 41 to control movement of the movable reflection device 50. The terminals 42 connect with an outer control unit (not shown), to control motion of the stepping motor 41. A retainer 44 attaches the stepping motor 41 to the fixing base 70 via a first screw 45.

The movable reflection device 50 includes a movable reflection member 51, a movable fixing frame 52, and a guide rod 53. The movable reflection member 51 is preferably a lens. The movable fixing frame 52 includes a top fixing surface 521, a T-slot 522, a spring member 523, a guide hole 524, and a transmitting groove 525. Thre ads are formed in the transmitting groove 525, to movably engage with the transmitting rod 43. The movable reflection member 51 is attached to the fixing surface 521. The guide rod 53 is inserted through the guide hole 524 of the movable fixing frame 52, for guiding the movable fixing frame 52 to slidingly move therealong. The spring member 523 comprises a stiff portion interferentially retained in the T-slot 522, and a resilient portion for resiliently abutting a rear wall of the fixing base 70. The spring member 523 thereby ensures that the movable reflection device 50 can move steadily along the guide rod 53.

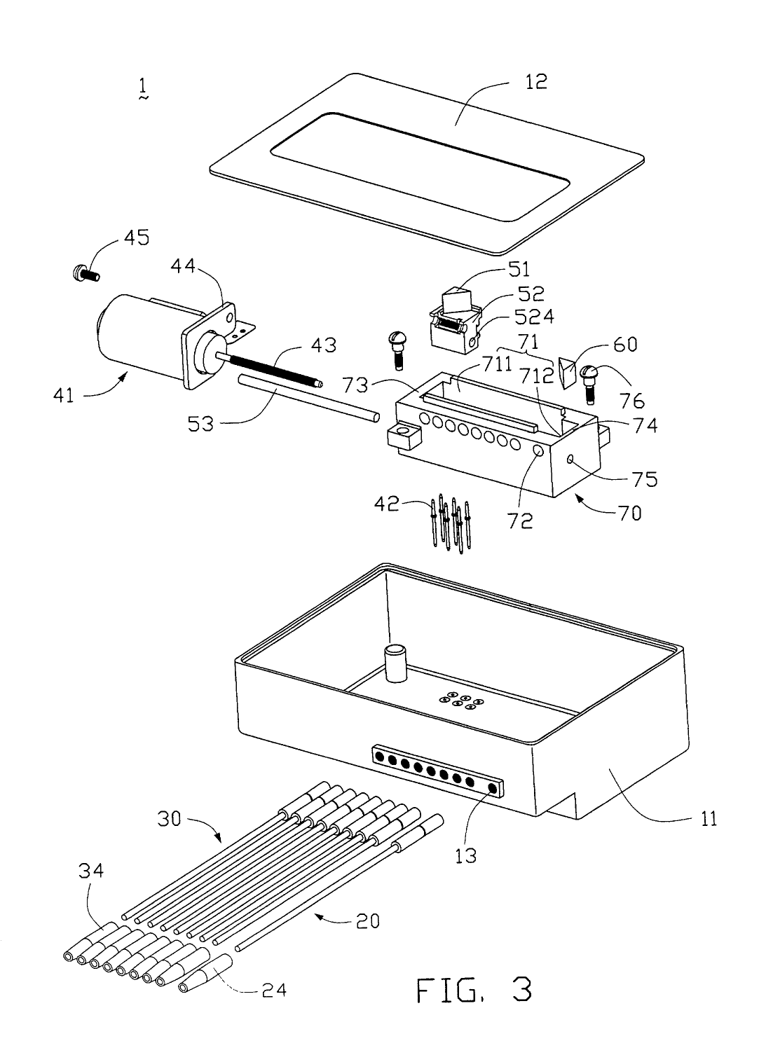

Referring to FIG. 3, the fixing base 70 includes a receiving channel 71, and a plurality of horizontally aligned second fixing holes 72 defined in a front wall of the fixing base 70. The second fixing holes 72 correspond to the first fixing holes 13 of the casing 11, and are for accommodating the collimating lenses 23, 33. A pair of fixing bores 75 is respectively defined in opposite end walls 73, 74 of the fixing base 70, for rotatably receiving the transmitting rod 43 of the driving device 40 therein. The receiving channel 71 comprises a first receiving portion 711 for receiving the movable reflection device 50, and a second receiving portion 712 for receiving the fixed reflection member 60. A positioning hole (not shown) is defined in the end wall 73, and a positioning groove (not shown) is defined in an inner surface of the end wall 74. The positioning hole and positioning groove positioningly receive the guide rod 53 of the movable reflection device 50. A pair of second screws 76 is for fixing the fixing base 70 in the casing 11.

In assembly of the optical switch 1, the movable fixing frame 52 is placed in the first portion 711 of the receiving channel 71 of the fixing base 70. The guide rod 53 is successively inserted through the positioning hole of the end wall 73, into the receiving groove 71, through the guide hole 524 of the movable fixing frame 52, and into the positioning groove of the end wall 74. Thus the movable reflection device 50 is movably attached to the fixing base 70.

The fixed reflection member 60 is placed in the second receiving portion 712 of the receiving groove 71, and aligned with an endmost second fixing hole 72 that corresponds to the input fiber 21. The first screw 45 threadedly engages the retainer 44 on the fixing base 70. The driving device 40 is thereby attached to the fixing base 70. The transmitting rod 43 is received in the receiving channel 71 and the fixing bore 75, and rotatably engages in the transmitting groove 525 of the movable fixing frame 52. The movable reflection device 50 is movably fixed on the guide rod 53. The movable reflection member 51 is fixed on the movable fixing frame 52. The fixing base 70 is secured in the casing 11 with the second screws 76. The collimating lenses 23, 33 and ferrules 22, 32 of the input and output devices 20, 30 are respectively passed through the first fixing holes 13 of the casing 11. The collimating lenses 23, 33 are respectively fixed in the second fixing holes 72 of the fixing base 70. The securing members 24, 34 are respectively fixed in the first fixing holes 13, to prevent excessive bending of the input and output fibers 21, 31. Finally, the cover 12 is attached on the casing 11 to provide a sealed enclosure of the optical switch 1.

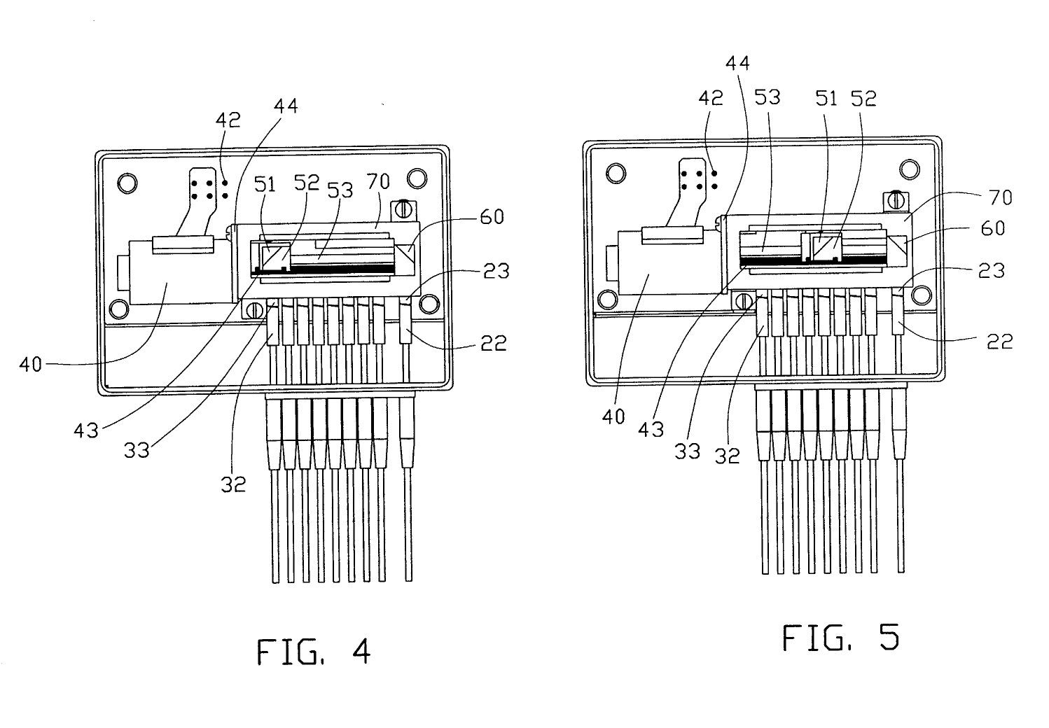

FIGS. 4 and 5 illustrate use of the optical switch 1 to switch optical paths between the input fiber 21 and the output fibers 31. In FIG. 4, the movable fixing frame 52 is positioned in the fixing base 70 opposite an endmost output fiber 31. Thus an optical path is defined between the input fiber 21 and the endmost output fiber 31. The fixed reflection member 60 reflects incoming optical signals from the input fiber 21 to the movable reflection member 51, and the movable reflection member 51 reflects the reflected optical signals to the endmost output fiber 31. To change from FIG. 4 to FIG. 5, an electrical instruction signal is transmitted to the driving device 40 via the terminals 42. The transmitting rod 43 accordingly drives the movable fixing frame 52 along the guide rod 53 to move toward a next position opposite to a desired next output fiber 31. A desired next optical path is thereby defined between the input fiber 21 and the desired next output fiber 31. Thus switching of optical paths is easily performed.

The optical switch 1 of the present invention only needs the movable and fixed reflection members 51, 60 to accomplish light transmission between the input device 20 and any one of the output devices 30. This simple light transmission path gives the optical switch 1 low insertion loss. In addition, a distance between the movable and fixed reflection members 51, 60 is adjustable. Therefore, in assembly of the optical switch 1, only a relative angle between reflection surfaces of the movable and fixed reflection members 51, 60 needs to be precisely formed. Assembly of the optical switch 1 is accordingly convenient and easy.

It should be understood that various changes and modifications to the presently preferred embodiment described herein will be apparent to those skilled in the art. Such changes and modifications may be made without departing from the spirit and scope of the present invention and without diminishing the present invention's advantages. Thus, it is intended that such changes and modifications be covered by the appended claims.

1. An optical switch comprising:
a casing;
a cover attached to the casing;
a fixing base received in the casing;
an input device connected with the fixing base for conveying optical signals to a fixed reflection member; and
a plurality of output devices connected with the fixing base for receiving optical signals from a movable reflection member; wherein
the fixed reflection member and the movable reflection member are both attached to the fixing base, and the movable reflection member can convey optical signals being reflected from the fixed reflection member to any of the output devices.

2. The optical switch as described in claim 1, further comprising a movable fixing frame, the movable reflection member being attached to the movable fixing frame.

3. The optical switch as described in claim 2, wherein the fixing base defines a receiving channel, the fixed reflection member is attached to the fixing base in the receiving channel, and the movable fixing frame is received in the receiving channel.

4. The optical switch as described in claim 2, wherein the movable fixing frame defines a threaded transmitting groove therein.

5. The optical switch as described in claim 2, further comprising a guide rod movably engaged with the movable fixing frame.

6. The optical switch as described in claim 4, further comprising a driving device drivably connected to the movable reflection member.

7. The optical switch as described in claim 2, wherein the movable fixing frame can move along a straight path to positionally correspond to any of the output devices.

8. The optical switch as described in claim 6, wherein the driving device comprises a stepped motor connecting with a transmitting rod, and the transmitting rod threadedly engages in the transmitting groove of the movable fixing frame.

9. The optical switch as described in claim 8, wherein the stepped motor drives the transmitting member, and the transmitting member drives the movable fixing frame to move along the guide rod.

10. An optical switch comprising:
a casing;
a cover attached to the casing;
a fixing base received in the casing;
an input device connected with the fixing base for conveying optical signals to a fixed reflection member;
a plurality of output devices connected with the fixing base for receiving optical signals from a movable reflection member;
a driving device attached to the casing to drive the movable reflection member to move along a straight path to positionally correspond to any of the output devices;
wherein the fixed reflection member and the movable reflection member are received in a receiving channel of the fixing base, the fixed reflection member reflects optical beams received from the input device, and the movable reflection member conveys optical signals being reflected from the fixed reflection member to any of the output devices.

11. The optical switch as described in claim 10, further comprising a movable fixing frame, the movable reflection member being attached to the movable fixing frame.

12. The optical switch as described in claim 11, wherein the movable fixing frame defines a threaded transmitting groove therein.

13. The optical switch as described in claim 11, further comprising a guide rod movably engaged with the movable fixing frame.

14. The optical switch as described in claim 12, further comprising a driving device drivably connected to the movable reflection member.

15. The optical switch as described in claim 14, wherein the driving device comprises a stepped motor connecting with a transmitting member, and the transmitting member threadedly engages in the transmitting groove of the movable fixing frame.

16. The optical switch as described in claim 15, wherein the stepped motor drives the transmitting member, and the transmitting member drives the movable fixing frame to move along the guide rod.

17. A 1×N optical switch comprising:
a single input device aligned with a fixed reflection member in a first direction;
a plurality of juxtaposed output devices facing to a common direction;
a moveable reflection member moving along and aligned with the fixed reflection member in a second direction, said moveable reflection member defining a plurality of positions respectively aligned with the corresponding output devices in a third direction; wherein
light coming from the input device, via a path constituted by said first, second and third directions, leaves from the corresponding output device.

18. The switch as described in claim 17, wherein said the second direction is perpendicular to the first and the third directions.

19. The switch as described in claim 17, wherein said third direction is parallel to said first direction.

20. The switch as described in claim 19, wherein said third direction is same with the first direction.
